(19) United States
(12) Patent Application Publication
(10) Pub. No.: US 2025/0342324 A1
(43) Pub. Date: Nov. 6, 2025

(54) METHOD AND SYSTEM FOR PROVIDING QUESTION-ANSWERING SERVICE BASED ON LARGE LANGUAGE MODEL

(71) Applicants: SAMSUNG SDS CO., LTD., Seoul (KR); SAMSUNG BIOLOGICS CO. , LTD., Incheon (KR)

(72) Inventors: Seong Il CHO, Incheon (KR); Hyeok Geon KWON, Incheon (KR); Ki Sung SHIM, Incheon (KR); Da Ye Seul LIM, Incheon (KR); Song Hee PARK, Incheon (KR); Hee Young LEE, Seoul (KR); Yong Bin YIM, Seoul (KR); Enoch KIM, Seoul (KR); Min Kee JUNG, Seoul (KR); Nam Kee LEE, Seoul (KR); Jun Il KIM, Seoul (KR); Jae Hoon CHOI, Seoul (KR); Seung Ho LEE, Seoul (KR); Hye Ran LEE, Seoul (KR); Jong In BAE, Seoul (KR)

(73) Assignees: SAMSUNG SDS CO., LTD., Seoul (KR); SAMSUNG BIOLOGICS CO. , LTD., Incheon (KR)

(21) Appl. No.: 19/266,684

(22) Filed: Jul. 11, 2025

(30) Foreign Application Priority Data
Jan. 22, 2024 (KR) 10-2024-0092538
Oct. 30, 2024 (KR) 10-2024-0150744

(51) Int. Cl. G06F 40/40; G06F 40/35

(52) U.S. Cl. CPC G06F 40/40; G06F 40/35

(57) ABSTRACT

A large language model (LLM)-based method includes receiving, from a user terminal, a transition command to a project-type chat window and information regarding a project execution period; in response to receipt of the transition command, determining a context retention period for the project-type chat window using the information regarding the project execution period; automatically generating a prompt for generating, using the LLM, a response to a query input from the user terminal, wherein the prompt is automatically generated to include the second query and information on one of a plurality of topics corresponding to the project-type chat window designated in the second query, and the response is generated in consideration of contexts of a plurality of conversations during the context retention period of the project-type chat window; and transmitting the response received from the LLM using the prompt, as a response to the second query, to the user terminal.

### CROSS-REFERENCE TO RELATED APPLICATIONS

This application claims priority from Korean Patent Application No. 10-2024-0092538 filed on Jul. 12, 2024, and Korean Patent Application No. 10-2024-0150744 filed on Oct. 30, 2024, in the Korean Intellectual Property Office, and all the benefits accruing therefrom under 35 U.S.C. 119, the contents of which in its entirety are herein incorporated by reference.

### BACKGROUND

### 1. Field

The present disclosure relates to a question-answering service provision method and system, and more specifically, to a method and system for providing a user interface such as a chat window for delivering a question-answering service.

### 2. Description of the Related Art

A question-answering service based on generative artificial intelligence (AI) technology is being provided. An example of the generative AI technology is a large language model (LLM). An LLM, which is a technique of learning from a vast amount of text data to understand the context of language and generate new text, understands user questions and provides appropriate answers.

However, an LLM may fail to generate an answer that aligns with the user's intention when the user's question is ambiguous. To address this issue, there is a need for a technology that recommends refined questions or helps construct clear questions to derive answers that meet the user's purpose.

In addition, most LLMs, including ChatGPT, maintain memory of the content of conversations only within individual sessions. Once each session ends, the context is lost. That is, while LLMs can understand context and provide connected responses within the current conversation, they cannot recall the previous conversation once a new conversation begins.

Accordingly, there is a need to provide an LLM-based question-answering service that maintains the conversation context even after each session ends, so that past conversations can be reused in project-based tasks.

### SUMMARY

An objective of the present disclosure is to provide a large language model (LLM)-based question-answering service provision method that offers a special chat window in which conversation context is maintained for a user-specified period.

Another objective of the present disclosure is to provide an LLM-based question-answering service provision method that offers a chat window which induces the input of questions with one or more designated topics and generates answers associated with the topics.

Yet another objective of the present disclosure is to provide an LLM-based question-answering service provision method that, in response to receipt of a response from an LLM containing a variety of vocabulary unique to each user, provides a transformed response with vocabulary that is easier to understand.

The objectives of the present disclosure are not limited to those mentioned above, and other objectives not explicitly stated will be clearly understood by those skilled in the art based on the following description.

According to an aspect of the present disclosure, there is provided a large language model (LLM)-based question-answering service provision method provided by a computing system. The large language model (LLM)-based question-answering service provision method may comprise generating, using a first LLM, a first response to a first query input from a user terminal of a first user, transmitting the first response to the user terminal so that the first response is displayed in a general chat window displayed on the user terminal, receiving, from the user terminal, a transition command to a project-type chat window and information regarding a project execution period, in response to receipt of the transition command, determining a context retention period for the project-type chat window using the information regarding the project execution period, automatically generating a prompt for generating, using the first LLM, a second response to a second query input from the user terminal, wherein the prompt is automatically generated to include the second query and information on one of a plurality of topics corresponding to the project-type chat window designated in the second query, and the second response is generated in consideration of contexts of a plurality of conversations during the context retention period of the project-type chat window, and transmitting the second response received from the first LLM using the prompt, as a response to the second query, to the user terminal.

In some embodiments, the automatically generating of the prompt comprises: referencing a topic dictionary that includes topic-related information of a plurality of queries received during the context retention period of the project-type chat window, and determining, in consideration of the contexts of the plurality of conversations during the context retention period of the project-type chat window, one piece of topic-related information among the topic-related information of the plurality of queries included in the referenced topic dictionary, the prompt is generated to include the determined piece of topic-related information.

In some embodiments, the receiving of the transition command and the information regarding the project execution period from the user terminal comprises receiving, from the user terminal, information on a plurality of topics corresponding to the project-type chat window.

In some embodiments, the determining of the context retention period comprises determining the context retention period for the project-type chat window by adding a predefined period to the information regarding the project execution period, and the predefined period is a period determined in consideration of contexts of a plurality of conversations in the general chat window.

In some embodiments, the automatically generating of the prompt comprises: referencing information regarding the first user's work, which is pre-stored in a vector database, and calculating a similarity between the information regarding the first user's work and the second query, and augmenting the automatically generated prompt by referencing a piece of information related to the first user's work with a high calculated similarity among the information regarding the first user's work.

In some embodiments, the automatically generating of the prompt for generating the second response comprises: transmitting a predefined Structured Query Language (SQL) template to the user terminal to convert the second query into an SQL statement, wherein the SQL template includes information regarding a condition for converting the second query into the SQL statement, receiving information of the SQL template from the user terminal, converting the second query into the SQL statement in consideration of the received information of the SQL template, and obtaining the second response to the second query, converted into the SQL statement, from the LLM.

In some embodiments, the obtaining of the second response to the second query comprises: replacing vocabulary included in the second response with one or more tokens by performing morpheme analysis on the vocabulary, converting the one or more tokens into predefined vocabulary, and transmitting a second response including the predefined vocabulary to the user terminal.

In some embodiments, the automatically generating of the prompt for generating the second response may comprise determining a document to be referenced for the second response to the second query with reference to the generated prompt, transmitting a plurality of usage options for the determined document to the user terminal so that the plurality of usage options are displayed on the user terminal, receiving, from the user terminal, information on one usage option selected from among the plurality of usage options for the determined document, and obtaining the second response to the second query with reference to the determined document and the received information on the selected usage option.

In some embodiments, the obtaining of the second response to the second query with reference to the determined document comprises: performing morpheme analysis on vocabulary included in the second query and replacing the vocabulary with tokens, converting the tokens into predefined vocabulary, and transmitting the second response including the predefined vocabulary to the user terminal.

In some embodiments, the determining of the document to be referenced comprises: in response to receipt of a second query including a predefined identifier from the user terminal, displaying, in a popup window, one or more documents having document names containing content following the predefined identifier.

In some embodiments, the obtaining of the second response to the second query with reference to the determined document comprises transmitting, to the user terminal, a name of the determined document and a page number referenced within the determined document as a source of the second response, wherein the source of the second response provides a link for accessing original data of the determined document.

In some embodiments, the automatically generating of the prompt comprises classifying, by context, a plurality of conversations during the context retention period of the project-type chat window and visualizing the classified conversations for reference in the generating of the second response to the second query.

In some embodiments, the visualizing of the classified conversations may comprise receiving, from the user terminal, a request for displaying, in the project-type chat window, one conversation classified under a specific context among the visualized conversations, and in response to receipt of the request, displaying the corresponding conversation in the project-type chat window.

According to another aspect of the present disclosure, there is provided a large language model (LLM)-based question-answering service provision system. The large language model (LLM)-based question-answering service provision system may comprise at least one processor, and a memory storing a computer program executed by the at least one processor, wherein, when the computer program is executed, the at least one processor is configured to: generate, using a first LLM, a first response to a first query input from a user terminal of a first user, transmit the first response to the user terminal so that the first response is displayed in a general chat window displayed on the user terminal, receive, from the user terminal, a transition command to a project-type chat window and information regarding a project execution period, in response to receipt of the transition command, determine a context retention period for the project-type chat window using the information regarding the project execution period, automatically generate a prompt for generating, using the first LLM, a second response to a second query input from the user terminal, wherein the prompt is automatically generated to include the second query and information on one of a plurality of topics corresponding to the project-type chat window designated in the second query, and the second response is generated in consideration of contexts of a plurality of conversations during the context retention period of the project-type chat window, and transmit the second response received from the first LLM using the prompt, as a response to the second query, to the user terminal.

In some embodiments, the prompt is generated by referencing a topic dictionary that includes topic-related information of a plurality of queries received during the context retention period of the project-type chat window, and determining, in consideration of contexts of the plurality of conversations during the context retention period of the project-type chat window, one piece of topic-related information among the topic-related information of the plurality of queries included in the referenced topic dictionary so that the prompt includes the determined piece of topic-related information.

In some embodiments, the context retention period of the project-type chat window is determined by adding a predefined period to the information regarding the project execution period, and the predefined period is a period determined in consideration of contexts of a plurality of conversations in the general chat window.

In some embodiments, the prompt is augmented by referencing information regarding the first user's work, which is pre-stored in a vector database, calculating a similarity between the information regarding the first user's work and the second query, and referencing a piece of information regarding the first user's work with a high calculated similarity among the information regarding the first user's work.

In some embodiments, a plurality of conversations during the context retention period of the project-type chat window are classified by context and visualized for reference in the generation of the second response to the second query.

In some embodiments, the LLM-based question-answering service provision system receives, from the user terminal, a request for displaying, in the project-type chat window, one conversation classified under a specific context among the visualized conversations, and in response to receipt of the request, displays the corresponding conversation in the project-type chat window.

According to still another aspect of the present disclosure, there is a non-transitory computer readable recording medium storing a computer program, wherein the computer program is combined with a computing device to execute steps. The computer program may comprise generating, using a first large language model (LLM), a first response to a first query input from a user terminal of a first user, transmitting the first response to the user terminal so that the first response is displayed in a general chat window displayed on the user terminal, receiving, from the user terminal, a transition command to a project-type chat window and information regarding a project execution period, in response to receipt of the transition command, determining a context retention period for the project-type chat window using the information regarding the project execution period, automatically generating a prompt for generating, using the first LLM, a second response to a second query input from the user terminal, wherein the prompt is automatically generated to include the second query and information on one of a plurality of topics corresponding to the project-type chat window designated in the second query, and the second response is generated in consideration of contexts of a plurality of conversations during the context retention period of the project-type chat window, and transmitting the second response received from the first LLM using the prompt, as a response to the second query, to the user terminal.

It should be noted that the effects of the present disclosure are not limited to those described above, and other effects of the present disclosure will be apparent from the following description.

### BRIEF DESCRIPTION OF THE DRAWINGS

The above and other aspects and features of the present disclosure will become more apparent by describing exemplary embodiments thereof in detail with reference to the attached drawings, in which:

FIG. 1 is a block diagram of an overall system in which a large language model (LLM)-based question-answering service provision method according to an embodiment of the present disclosure is performed;

FIG. 2 is a flowchart illustrating an LLM-based question-answering service provision method according to an embodiment of the present disclosure;

FIG. 3 is a diagram illustrating a transition from a general chat window to a project-type chat window of a user terminal by automatically determining one topic stored in a topic dictionary in consideration of the context of a conversation, in some embodiments of the present disclosure;

FIG. 4 is a detailed flowchart illustrating some steps of the LLM-based question-answering service provision method of FIG. 2;

FIG. 5 is a diagram illustrating a Structured Query Language (SQL) template received from a first user for converting a second query into an SQL statement, in some embodiments of the present disclosure;

FIG. 6 is a diagram illustrating an example of the process of converting the second query into an SQL statement based on information of the SQL template received from the first user, in some embodiments of the present disclosure;

FIG. 7 is a detailed flowchart illustrating some steps of the LLM-based question-answering service provision method of FIG. 2;

FIG. 8 is a diagram illustrating an example of the process of determining a document to be referenced for a second response, in some embodiments of the present disclosure;

FIG. 9 is a diagram illustrating an example of the process of receiving a usage option for a document to be referenced for the second response, in some embodiments of the present disclosure;

FIG. 10 is a diagram illustrating an example of the process of masking vocabulary included in the second response, in some embodiments of the present disclosure;

FIG. 11 is a diagram illustrating an example of the process of converting vocabulary included in the second response into a synonym, in some embodiments of the present disclosure;

FIG. 12 is a diagram illustrating an example of the process of converting vocabulary included in the second response into its expanded or abbreviated form, in some embodiments of the present disclosure;

FIG. 13 is a diagram illustrating an example of the process of displaying, in the project-type chat window, a conversation including a context in response to a request from the first user, in some embodiments of the present disclosure; and

FIG. 14 is a block diagram illustrating the hardware configuration of an LLM-based question-answering service provision system according to an embodiment of the present disclosure.

### DETAILED DESCRIPTION

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Hereinafter, embodiments of the present disclosure will be described with reference to the attached drawings.

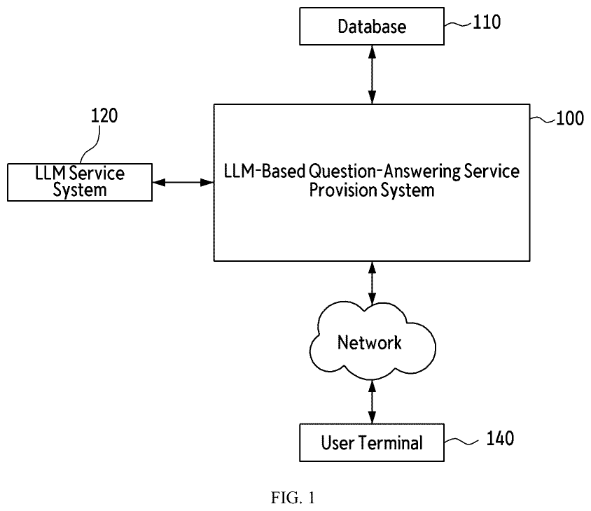

FIG. 1 is a block diagram of an overall system in which a large language model (LLM)-based question-answering service provision method according to an embodiment of the present disclosure is performed. Referring to FIG. 1, the system according to an embodiment of the present disclosure may operate in conjunction with an LLM-based question-answering service provision system 100, a database 110, and a user terminal 140.

The user terminal 140 may transmit data of a user request to the LLM-based question-answering service provision system 100. The user request, which is a request for execution of one or more actions, may be described as natural language text or data of various modalities including natural language text. For example, the user request may indicate sequential execution of a first action, a second action, and a third action and transmission of the result of the sequential execution to a specific recipient's web.

The LLM-based question-answering service provision system 100 is connected to the user terminal 140 via a network, receives the user request from the user terminal 140, and may generate a processing result for the user request. The LLM-based question-answering service provision system 100, which transmits the generated processing result to the user terminal 140, may be a computing system composed of one or more physical servers or one or more cloud compute instances.

The database 110, which is a storage device that stores information regarding the user's work, may be referenced when generating a processing result for the user request. For example, by vectorizing the work-related information and measuring its similarity to the user's request, the processing result for the user's request may be generated with reference to a piece of such information with a high similarity.

For convenience, the LLM-based question-answering service provision system 100 may also be referred to as a service system, and an LLM service system 120 may also be referred to as an LLM.

The service system 100 may operate in conjunction with the LLM service system 120. The LLM service system 120 may be a system that generates a processing result for a user request. For example, the LLM service system 120 may convert the user request in natural language form into a prompt and generate a processing result in natural language form.

The service system 100 will be more fully understood with reference to other embodiments to be described below. In addition, technical ideas understood through the aforementioned embodiment of the service system 100 may also be reflected in other embodiments to be described below, even if not explicitly stated.

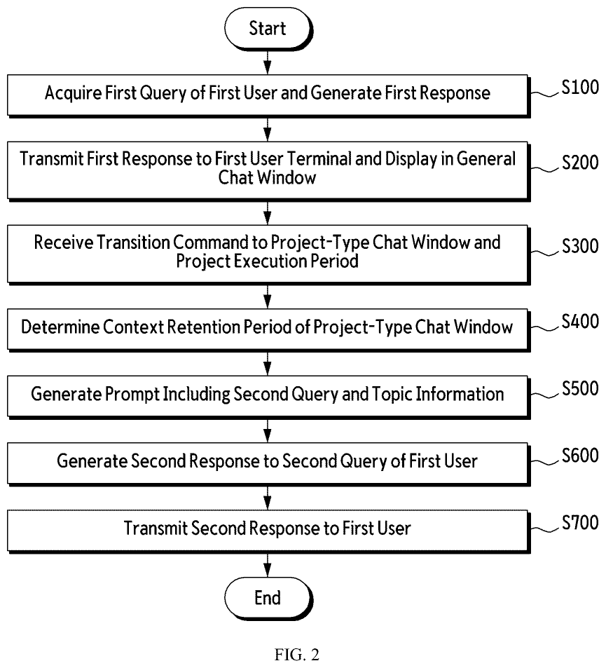

FIG. 2 is a flowchart illustrating a process of generating a response to a first user query and transmitting the response to the user terminal of a first user according to an embodiment of the present disclosure.

Referring to FIG. 2, in step S100, a first query is input from the user terminal, and a first response to the first query is generated using an LLM. An LLM-based question-answering service provision method according to an embodiment of the present disclosure may be performed by one or more computing systems. Also, in the LLM-based question-answering service provision method according to an embodiment of the present disclosure, some operations or steps may be performed by a first computing device and the remaining operations or steps may be performed by a second computing device. For example, some operations of the LLM-based question-answering service provision method according to an embodiment of the present disclosure may be performed by a service server, and the remaining operations may be performed by the user terminal. In the description that follows, if the subject entity of each operation or step is omitted, the subject entity is to be understood as a computing system. It is also to be noted that the embodiment described above with reference to FIG. 1 may naturally be applicable to the LLM-based question-answering service provision method according to an embodiment of the present disclosure, even if not explicitly stated.

In step S200, the first response is transmitted to the user terminal so that it is displayed in a general chat window displayed on the user terminal. The general chat window may receive a user query, and in response to receipt of the user query, may generate a response to the query using the LLM and transmit the response.

The LLM-based question-answering service provision method according to an embodiment of the present disclosure may include receiving a transition command requesting a switch from the general chat window to a project-type chat window and information regarding a project execution period from the user terminal (S300). The information regarding the project execution period may include a period expected to be required by the user to perform work using the LLM-based question-answering service according to an embodiment of the present disclosure.

A user query may be received through the project-type chat window, and in response to receipt of the user query, a response to the query may be generated and transmitted using the LLM. The project-type chat window may retain the user's past conversation context according to a context retention period, and may be referenced when generating a response to a new user query. Through the project-type chat window, even in situations where past conversation content is frequently reused for continuous tasks, responses suited to the user's purpose may be generated when queries are made in the project chat window.

The LLM-based question-answering service provision method according to an embodiment of the present disclosure may include, in response to receipt of the transition command from the user terminal, determining the conversation context retention period of the project-type chat window (S400). The conversation context retention period may be determined by adding a predefined period to the information regarding the project execution period. The predefined period may be designated in consideration of multiple conversation contexts in the general chat window. The transition command may include a command to switch the general chat window displayed on the user terminal to the project-type chat window.

For example, when a transition command from the general chat window to the project-type chat window is received from the user terminal and the project execution period is from Apr. 1, 2024 to Jun. 1, 2024, the conversation context retention period may be determined as extending to Jul. 1, 2024, which is one month after the end of the project execution period, Jun. 1, 2024. The one-month period may be lengthened or shortened depending on the multiple conversation contexts in the general chat window.

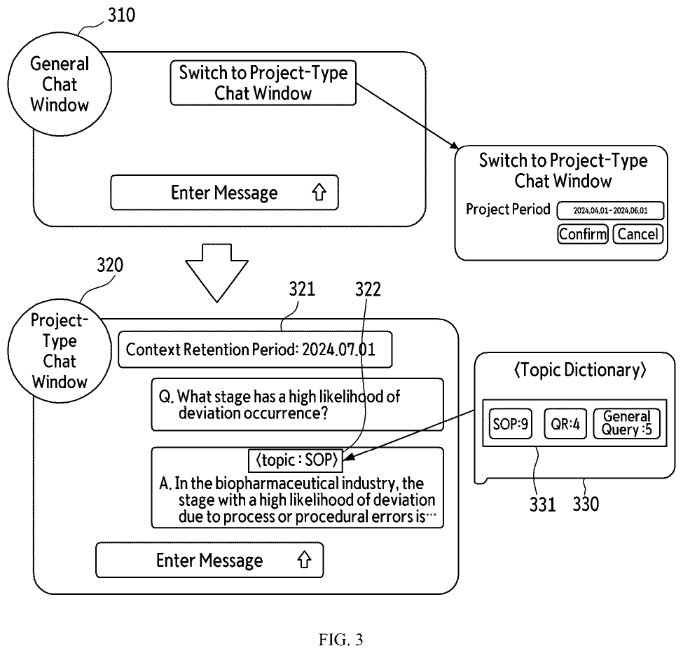

The LLM-based question-answering service provision method according to an embodiment of the present disclosure may include receiving a second query from the user terminal, determining a topic of the second query, and generating a prompt for generating a second response to the second query using the LLM (S500). The prompt may be generated to include the second query and information on one of multiple topics corresponding to the project-type chat window, designated in the second query. The multiple topics corresponding to the project-type chat window may include information related to conversation subjects during the context retention period. The process of determining information on one of the multiple topics corresponding to the project-type chat window will hereinafter be described with reference to FIG. 3.

FIG. 3 is a diagram illustrating a transition from a general chat window to a project-type chat window of the user terminal by automatically determining one topic stored in a topic dictionary in consideration of the context of a conversation, in some embodiments of the present disclosure. Referring to FIG. 3, for example, in a project-type chat window 320, when a second query is received from the user terminal, a topic dictionary 330 storing information on a plurality of topics from queries received during a context retention period 321 may be referenced, and one of the topics stored in the topic dictionary 330 may be automatically determined as a topic 322 of the second query, considering the context of the second query. The information regarding the topics may include standard operating procedures (SOP), quick responses (QR), and general queries. In addition, information on the topic of the second query may be received from the user terminal and used to automatically generate a prompt.

The LLM-based question-answering service provision method according to an embodiment of the present disclosure may include generating a second response to the second query of the first user using the LLM (S600) and transmitting the second response to the user terminal of the first user (S700). The second response may be generated, taking into account multiple conversation contexts during the context retention period 321 of the project-type chat window 320.

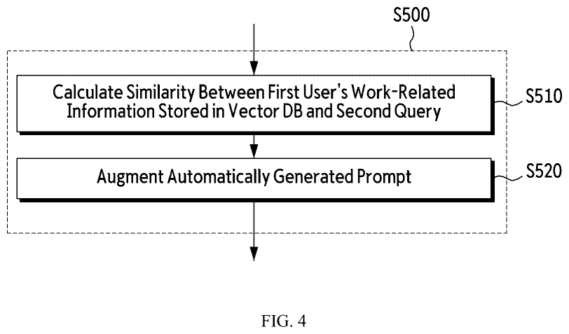

FIG. 4 is a flowchart illustrating a process of augmenting a prompt for obtaining the second response to the first user's second query with information regarding the first user's work, according to an embodiment of the present disclosure. Referring to FIG. 4, step S500 may include step S510 of calculating a similarity between the second query and the information regarding the first user's work, stored in a vector database. The information regarding the first user's work may be vectorized and stored in the vector database. Step S500 may further include step S520 of augmenting the prompt by referencing a piece of information regarding the first user's work with a high similarity, based on the result of the calculation.

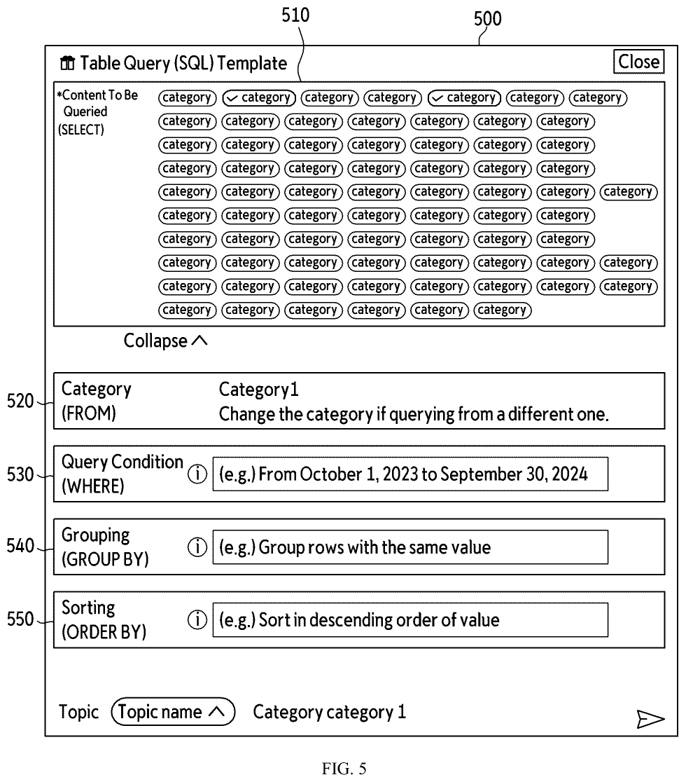

Step S500 may involve transmitting a predefined Structured Query Language (SQL) template 500 to the user terminal, wherein the SQL template 500 includes information regarding a condition for converting the second query into an SQL statement. FIG. 5 is a diagram illustrating exemplary detailed information of the SQL template received from the first user for converting the second query into an SQL statement, in some embodiments of the present disclosure. Referring to FIG. 5, for example, an SQL template 500 may include information on Content To Be Queried (SELECT) 510, Category (FROM) 520 of the content to be queried, Query Condition (WHERE) 530 of the content to be queried, Grouping (GROUP BY) 540 of the content to be queried, and Sorting (ORDER BY) 550 of the content to be queried.

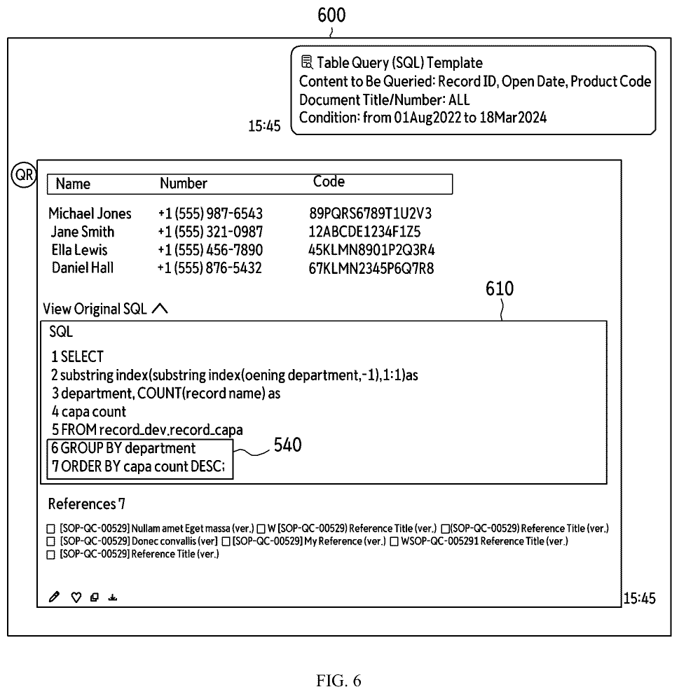

FIG. 6 is a diagram illustrating an example of the process of converting the second query into an SQL statement 610 based on the information on Content To Be Queried (SELECT) 510, Category (FROM) 520, Query Condition (WHERE) 530, Grouping (GROUP BY) 540, and Sorting (ORDER BY) 550 included in the SQL template 500, received from the first user, in some embodiments of the present disclosure. Referring to FIG. 6, for example, the second query may be converted into the SQL statement 610 by receiving, from the first user, the information on Content To Be Queried (SELECT) 510, Category (FROM) 520, Query Condition (WHERE) 530, Grouping (GROUP BY) 540, and Sorting (ORDER BY) 550 included in the SQL template 500. In addition, the original text of the SQL statement 610 and the Content To Be Queried (SELECT) 510, Category (FROM) 520, Query Condition (WHERE) 530, Grouping (GROUP BY) 540, and Sorting (ORDER BY) 550 included in the SQL template 500 may be visualized.

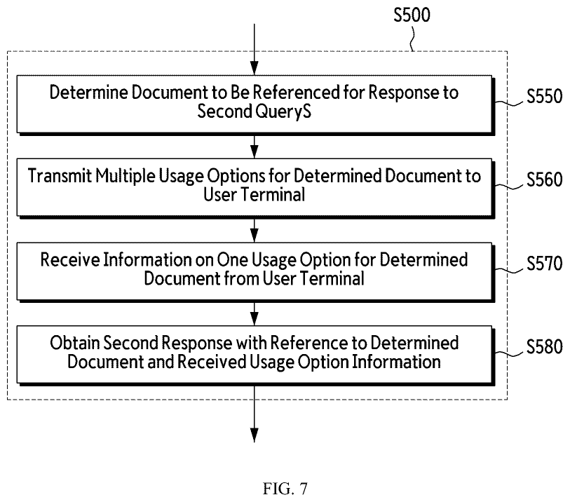

FIG. 7 is a flowchart illustrating a process of determining a document to be referenced and how to use the document during generation of the second response to the second query, according to an embodiment of the present disclosure. Referring to FIG. 7, step S500 may include step S550 of determining a document to be referenced for the second response to the first user's query, step S560 of transmitting to the user terminal a plurality of usage options for the determined document, step S570 of receiving information on one selected usage option for the determined document from the user terminal, and step S580 of generating the second response by referencing the determined document and the received usage option information.

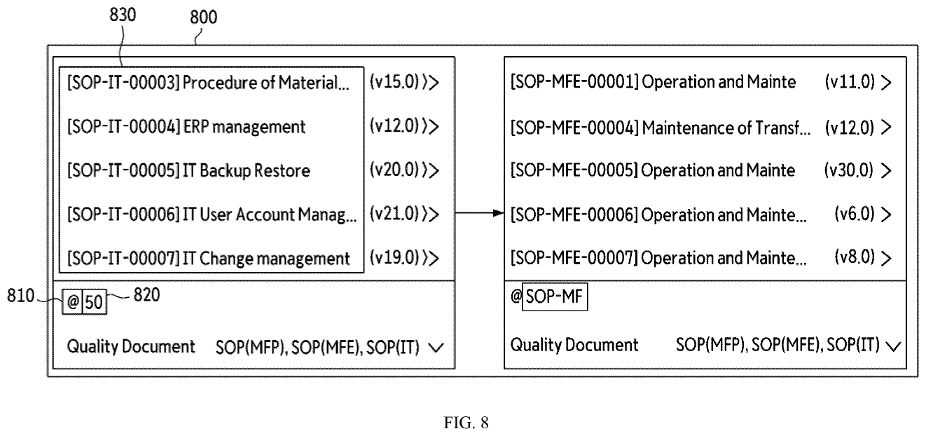

Step S550 may involve, in response to receiving, from the user terminal, a second query including a predefined identifier, displaying, in a popup window, one or more documents having document names containing the content following the predefined identifier. The process of displaying, in a popup window, one or more documents having document names including the content that follows the predefined identifier in response to receipt of the second query including the predefined identifier will hereinafter be described with reference to FIG. 8. FIG. 8 is a diagram illustrating an example of the process of determining a document to be referenced during the generation of the second response, in some embodiments of the present disclosure.

Referring to FIG. 8, a predefined identifier 810 may include “@.” When a second query including the predefined identifier 810 is received from the user terminal, one or more documents 830 having document names including content 820 that follows the identifier 810 may be displayed in a popup window.

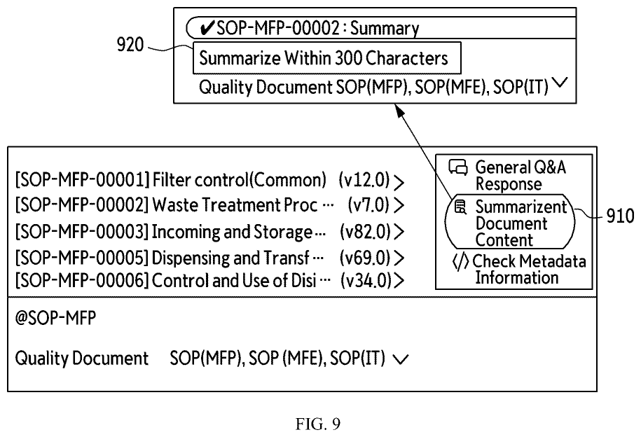

The process of receiving information on one usage option for a document determined to be referenced in the second response from the user terminal will hereinafter be described with reference to FIG. 9. FIG. 9 is a diagram illustrating an example of the process of receiving a usage option for a document to be referenced for the second response, in some embodiments of the present disclosure. Referring to FIG. 9, step S570 may include receiving, from the user, a selection of a usage option 910, from among a plurality of usage options, for the document to be referenced during the generation of the second response. The plurality of usage options may include a general Q&A method, a document summarization method, and a metadata checking method. In step S570, the user's detailed request 920 regarding the usage option 910 may also be input along with a selection of the usage option 910 from the user. For example, the user may input information on the usage option 910, the document summarization method, and may also input information on a specific summarization condition.

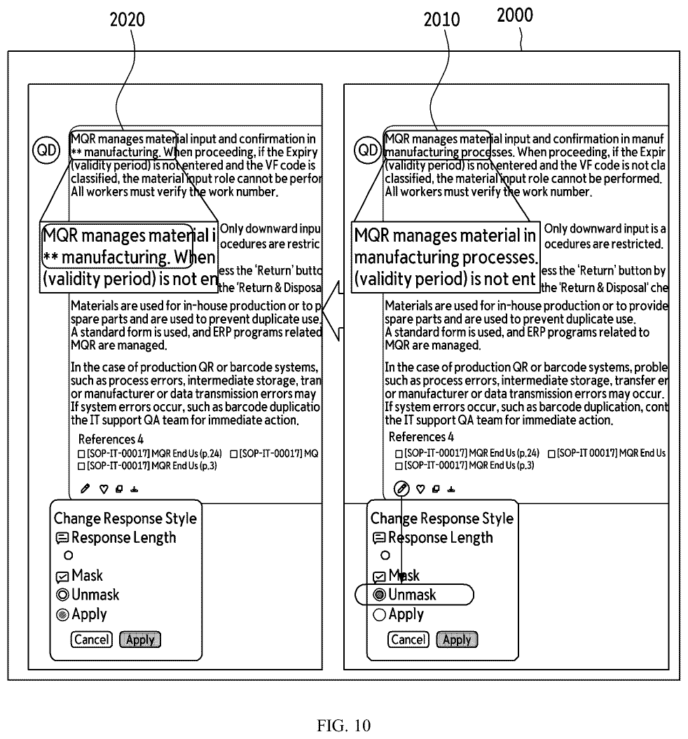

Step S580 may include converting vocabulary included in the second response into predefined vocabulary. The process of converting vocabulary included in the second response into predefined vocabulary will hereinafter be described in greater detail with reference to FIG. 10.

FIG. 10 is a diagram illustrating an example of the process of masking vocabulary included in the second response, in some embodiments of the present disclosure. Here, the term “masking” may refer to processing specific information so that it cannot be identified, for privacy protection. Referring to FIG. 10, when the vocabulary “process” is included in the first user's second query, as indicated by reference numeral 2010, the vocabulary “process” may be converted and masked as “**,” as indicated by reference numeral 2020. By providing a masking function, vocabulary related to sensitive company information or security can be masked to prevent exposure to an external party. In addition, the masking function may be disabled depending on the first user's needs.

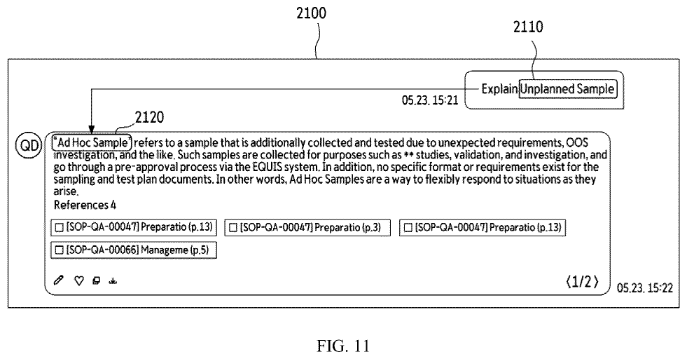

FIG. 11 is a diagram illustrating an example of the process of converting vocabulary included in the second response into synonyms, in some embodiments of the present disclosure. Referring to FIG. 11, when the vocabulary “unplanned sample” (2110) is included in the first user's second query, it may be converted into its synonym “Ad Hoc Sample” (2120). For example, the vocabulary 2110 may undergo morpheme analysis and be replaced at the level of tokens, and the replaced tokens may be converted into the vocabulary 2120. Also, a second response including the vocabulary 2120 may be transmitted to the user terminal. Since each user tends to use different vocabulary, standardizing the vocabulary improves the utility of the question-answering service and helps generate responses that match each user's intention. Here, the tokens may be obtained by dividing the vocabulary in the first user's second query into morphemes, and the morpheme analysis may refer to analyzing vocabulary in the first user's second query on the basis of morphemes, which are the smallest units of meaning.

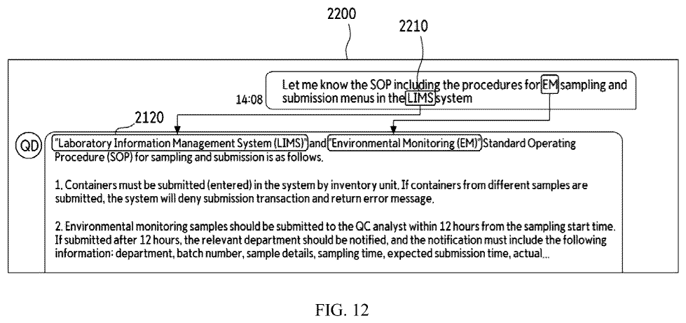

FIG. 12 is a diagram illustrating an example of the process of converting vocabulary included in the second response into its expanded or abbreviated form, in some embodiments of the present disclosure. Referring to FIG. 12, when vocabulary 2210 included in the second query is used to generate the second response to the second query and transmitted to the user terminal, it may be converted into an expanded or abbreviated form 2220.

For example, when the vocabulary “LIMS” is included in the second query, the second response to the second query may be generated and transmitted to the user terminal, and “LIMS” may be converted into its expanded form, “Laboratory Information Management System.” Conversely, when the vocabulary included in the second query is an expanded form, it may be converted into an abbreviated form when the second response to the second query is generated and transmitted to the user terminal. Since each user has a different level of understanding of certain vocabulary, converting the vocabulary into an expanded or abbreviated form can enhance each user's comprehension of the second response.

Step S580 may include transmitting, to the user terminal, the name of the determined document and the page number referenced within the determined document as the source of the second response. The source of the second response may include a link enabling access to the original data of the determined document. When an action such as a click is input from the user terminal, the link to the original data of the determined document may provide a visualization function. By providing detailed information on the determined document, the user may gain trust in the second response, and the time required to verify the reliability of the second response may be reduced, thereby improving user convenience.

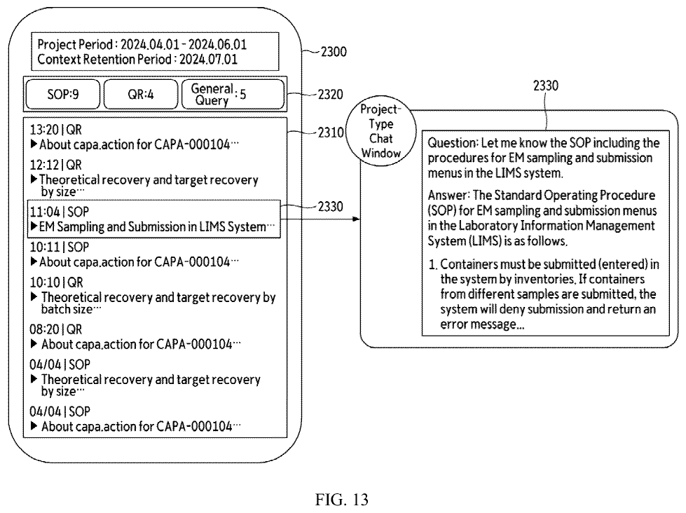

Step S500 may include classifying, by context, a plurality of conversations during the context retention period 321 of the project-type chat window and visualizing the classified conversations so they can be referenced during the generation of the second response. The visualization of the classified conversations may include receiving a request for the display of one of the classified conversations in the project-type chat window, and in response to receipt of the request, displaying the corresponding conversation in the project-type chat window. The process of classifying, by context, the plurality of conversations during the context retention period 321 of the project-type chat window and visualizing the classified conversations for reference for the second response will hereinafter be described in further detail with reference to FIG. 13.

FIG. 13 is a diagram illustrating an example of the process of displaying, in the project-type chat window, a conversation classified under a specific context in response to a request from the first user, in some embodiments of the present disclosure. Referring to FIG. 13, a plurality of conversations 2310 during the context retention period of the project-type chat window may be classified by context, as indicated by reference numeral 2320, and visualized, as indicated by reference numeral 2310, so that they can be referenced during the generation of the second response of the first user. A request may be received from the user terminal to display, in the project-type chat window, a conversation 2330 classified under a specific context, among the visualized conversations. In response to receipt of the request, the conversation 2330 may be displayed in the project-type chat window.

By classifying and visualizing, by context, the conversations during the context retention period of the project-type chat window, a response aligned with the first user's intention may be generated by utilizing past conversations that include similar contexts, and the first user may also reuse or revise such past conversations to reduce the time required to compose queries.

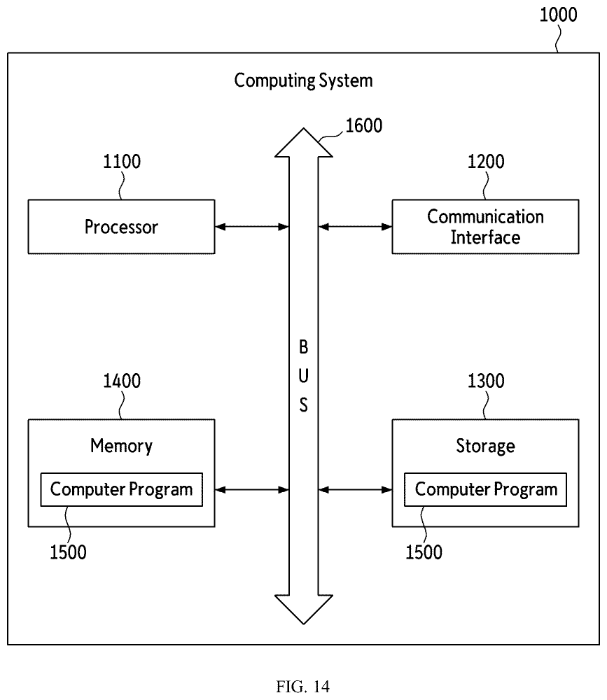

FIG. 14 is a block diagram illustrating the hardware configuration of an LLM-based question-answering service provision system according to an embodiment of the present disclosure.

Referring to FIG. 14, a computing system 1000 may include at least one processor 1100, a bus 1600, a communication interface 1200, a memory 1400 that loads a computer program 1500 to be executed by the processor 1100, and a storage 1300 that stores the computer program 1500. It is to be noted that only components relevant to embodiments of the present disclosure are illustrated in FIG. 14. Therefore, one skilled in the relevant art will understand that other general-purpose components, in addition to those illustrated, may also be included. That is, the computing system 1000 may include various additional components besides those depicted in FIG. 14. Furthermore, the computing system 1000 may be implemented with some of the components in FIG. 14 omitted. The components of the computing system 1000 will hereinafter be described. It is also to be noted that, throughout the present disclosure, the terms “computing system 1000” and “computing system” may be used interchangeably.

The processor 1100 may control the overall operations of the components of the computing system 1000. The processor 1100 may include at least one of a central processing unit (CPU), microprocessor unit (MPU), microcontroller unit (MCU), graphics processing unit (GPU), or any type of processor well known in the relevant technical field. The processor 1100 may also perform computation on at least one application or program for executing operations/methods according to embodiments of the present disclosure. The computing system 1000 may include one or more processors.

The memory 1400 may store various data, commands, and/or information. The memory 1400 may load the computer program 1500 from the storage 1300 in order to execute the operations/methods according to embodiments of the present disclosure. The memory 1400 may be implemented as a volatile memory such as random-access memory (RAM), but the present disclosure is not limited thereto.

The bus 1600 may provide a communication function among the components of the computing system 1000. The bus 1600 may be implemented in various forms such as an address bus, data bus, or control bus.

The communication interface 1200 may support wired or wireless internet communication of the computing system 1000. Additionally, the communication interface 1200 may support various other communication methods than internet communication. To this end, the communication interface 1200 may include communication modules well known in the relevant technical field.

The storage 1300 may non-temporarily store one or more computer programs 1500. The storage 1300 may be implemented with non-volatile memory such as read-only memory (ROM), erasable programmable ROM (EPROM), electrically erasable programmable ROM (EEPROM), or flash memory, a hard disk, a removable disk, or any form of computer-readable recording medium well known in the relevant technical field.

The computer program 1500 may include one or more instructions that cause the processor 1100 to perform operations/methods according to various embodiments of the present disclosure when loaded into the memory 1400. That is, the processor 1100 may perform the operations/methods according to various embodiments of the present disclosure by executing the one or more loaded instructions.

For example, the computing system 1000 of FIG. 14 may be a computing device included in the LLM-based question-answering service provision system 100 described with reference to FIG. 1. In this case, the computing system 1000 may be configured using one or more physical servers included in a server farm based on cloud technology such as a virtual machine. In this case, at least some of the components depicted in FIG. 14, such as the processor 1100, the memory 1400, and the storage 1300, may be virtual hardware, and the communication interface 1200 may also be implemented with virtualized networking elements such as a virtual switch. So far, various embodiments of the present disclosure and their effects have been described with reference to FIGS. 1 through 14. However, the technical effects of the present disclosure are not limited to those set forth herein, and other effects not explicitly mentioned may be clearly understood by one skilled in the relevant art based on the following description.

A computer program 1500 according to an embodiment of the present disclosure may include instructions to: generate, using a first LLM, a first response to a first query input from a user terminal of a first user; transmit the first response to the user terminal so that the first response is displayed in a general chat window displayed on the user terminal; receive, from the user terminal, a transition command to a project-type chat window and information regarding a project execution period; in response to receipt of the transition command, determine a context retention period for the project-type chat window using the information regarding the project execution period; automatically generate a prompt for generating, using the first LLM, a second response to a second query input from the user terminal, wherein the prompt is automatically generated to include the second query and information on one of a plurality of topics corresponding to the project-type chat window designated in the second query, and the second response is generated in consideration of the contexts of a plurality of conversations during the context retention period of the project-type chat window; and transmit the second response received from the first LLM using the prompt, as a response to the second query, to the user terminal.

So far, a variety of embodiments of the present disclosure and the effects according to embodiments thereof have been mentioned with reference to FIGS. 1 to 14. The effects according to the technical idea of the present disclosure are not limited to the forementioned effects, and other unmentioned effects may be clearly understood by those skilled in the art from the description of the specification.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications can be made to the preferred embodiments without substantially departing from the principles of the present disclosure. Therefore, the disclosed preferred embodiments of the disclosure are used in a generic and descriptive sense only and not for purposes of limitation.

What is claimed is:

1. A large language model (LLM)-based question-answering service provision method provided by a computing system, comprising:
generating, using a first LLM, a first response to a first query input from a user terminal of a first user;
transmitting the first response to the user terminal so that the first response is displayed in a general chat window displayed on the user terminal;
receiving, from the user terminal, a transition command to a project-type chat window and information regarding a project execution period;
in response to receipt of the transition command, determining a context retention period for the project-type chat window using the information regarding the project execution period;
automatically generating a prompt for generating, using the first LLM, a second response to a second query a input from the user terminal, wherein the prompt is automatically generated to include the second query and information on one of a plurality of topics corresponding to the project-type chat window designated in the second query, and the second response is generated in consideration of contexts of a plurality of conversations during the context retention period of the project-type chat window; and
transmitting the second response received from the first LLM using the prompt, as a response to the second query, to the user terminal.

2. The LLM-based question-answering service provision method of claim 1, wherein
the automatically generating of the prompt comprises: referencing a topic dictionary that includes topic-related information of a plurality of queries received during the context retention period of the project-type chat window; and determining, in consideration of the contexts of the plurality of conversations during the context retention period of the project-type chat window, one piece of topic-related information among the topic-related information of the plurality of queries included in the referenced topic dictionary,
the prompt is generated to include the determined piece of topic-related information.

3. The LLM-based question-answering service provision method of claim 1, wherein the receiving of the transition command and the information regarding the project execution period from the user terminal comprises receiving, from the user terminal, information on a plurality of topics corresponding to the project-type chat window.

4. The LLM-based question-answering service provision method of claim 1, wherein
the determining of the context retention period comprises determining the context retention period for the project-type chat window by adding a predefined period to the information regarding the project execution period, and
the predefined period is a period determined in consideration of contexts of a plurality of conversations in the general chat window.

5. The LLM-based question-answering service provision method of claim 1, wherein the automatically generating of the prompt comprises: referencing information regarding the first user's work, which is pre-stored in a vector database, and calculating a similarity between the information regarding the first user's work and the second query; and augmenting the automatically generated prompt by referencing a piece of information related to the first user's work with a high calculated similarity among the information regarding the first user's work.

6. The LLM-based question-answering service provision method of claim 1, wherein the automatically generating of the prompt for generating the second response comprises: transmitting a predefined Structured Query Language (SQL) template to the user terminal to convert the second query into an SQL statement, wherein the SQL template includes information regarding a condition for converting the second query into the SQL statement; receiving information of the SQL template from the user terminal; converting the second query into the SQL statement in consideration of the received information of the SQL template; and obtaining the second response to the second query, converted into the SQL statement, from the LLM.

7. The LLM-based question-answering service provision method of claim 6, wherein the obtaining of the second response to the second query comprises: replacing vocabulary included in the second response with one or more tokens by performing morpheme analysis on the vocabulary; converting the one or more tokens into predefined vocabulary; and transmitting a second response including the predefined vocabulary to the user terminal.

8. The LLM-based question-answering service provision method of claim 1, wherein the automatically generating of the prompt for generating the second response comprises: determining a document to be referenced for the second response to the second query with reference to the generated prompt; transmitting a plurality of usage options for the determined document to the user terminal so that the plurality of usage options are displayed on the user terminal; receiving, from the user terminal, information on one usage option selected from among the plurality of usage options for the determined document; and obtaining the second response to the second query with reference to the determined document and the received information on the selected usage option.

9. The LLM-based question-answering service provision method of claim 8, wherein the obtaining of the second response to the second query with reference to the determined document comprises: performing morpheme analysis on vocabulary included in the second query and replacing the vocabulary with tokens; converting the tokens into predefined vocabulary; and transmitting the second response including the predefined vocabulary to the user terminal.

10. The LLM-based question-answering service provision method of claim 8, wherein the determining of the document to be referenced comprises: in response to receipt of a second query including a predefined identifier from the user terminal, displaying, in a popup window, one or more documents having document names containing content following the predefined identifier.

11. The LLM-based question-answering service provision method of claim 8, wherein the obtaining of the second response to the second query with reference to the determined document comprises transmitting, to the user terminal, a name of the determined document and a page number referenced within the determined document as a source of the second response, wherein the source of the second response provides a link for accessing original data of the determined document.

12. The LLM-based question-answering service provision method of claim 1, wherein the automatically generating of the prompt comprises classifying, by context, a plurality of conversations during the context retention period of the project-type chat window and visualizing the classified conversations for reference in the generating of the second response to the second query.

13. The LLM-based question-answering service provision method of claim 12, wherein the visualizing of the classified conversations comprises: receiving, from the user terminal, a request for displaying, in the project-type chat window, one conversation classified under a specific context among the visualized conversations; and in response to receipt of the request, displaying the corresponding conversation in the project-type chat window.

14. A large language model (LLM)-based question-answering service provision system, comprising:
at least one processor; and
a memory storing a computer program executed by the at least one processor,
wherein, when the computer program is executed, the at least one processor is configured to: generate, using a first LLM, a first response to a first query input from a user terminal of a first user; transmit the first response to the user terminal so that the first response is displayed in a general chat window displayed on the user terminal; receive, from the user terminal, a transition command to a project-type chat window and information regarding a project execution period; in response to receipt of the transition command, determine a context retention period for the project-type chat window using the information regarding the project execution period; automatically generate a prompt for generating, using the first LLM, a second response to a second query input from the user terminal, wherein the prompt is automatically generated to include the second query and information on one of a plurality of topics corresponding to the project-type chat window designated in the second query, and the second response is generated in consideration of contexts of a plurality of conversations during the context retention period of the project-type chat window; and transmit the second response received from the first LLM using the prompt, as a response to the second query, to the user terminal.

15. The LLM-based question-answering service provision system of claim 14, wherein the prompt is generated by referencing a topic dictionary that includes topic-related information of a plurality of queries received during the context retention period of the project-type chat window, and determining, in consideration of contexts of the plurality of conversations during the context retention period of the project-type chat window, one piece of topic-related information among the topic-related information of the plurality of queries included in the referenced topic dictionary so that the prompt includes the determined piece of topic-related information.

16. The LLM-based question-answering service provision system of claim 14, wherein
the context retention period of the project-type chat window is determined by adding a predefined period to the information regarding the project execution period, and
the predefined period is a period determined in consideration of contexts of a plurality of conversations in the general chat window.

17. The LLM-based question-answering service provision system of claim 14, wherein the prompt is augmented by referencing information regarding the first user's work, which is pre-stored in a vector database, calculating a similarity between the information regarding the first user's work and the second query, and referencing a piece of information regarding the first user's work with a high calculated similarity among the information regarding the first user's work.

18. The LLM-based question-answering service provision system of claim 14, wherein a plurality of conversations during the context retention period of the project-type chat window are classified by context and visualized for reference in the generation of the second response to the second query.

19. The LLM-based question-answering service provision system of claim 18, wherein
the LLM-based question-answering service provision system receives, from the user terminal, a request for displaying, in the project-type chat window, one conversation classified under a specific context among the visualized conversations, and in response to receipt of the request, displays the corresponding conversation in the project-type chat window.

20. A non-transitory computer readable recording medium storing a computer program,
wherein the computer program is combined with a computing device to execute steps comprising,
generating, using a first large language model (LLM), a first response to a first query input from a user terminal of a first user;
transmitting the first response to the user terminal so that the first response is displayed in a general chat window displayed on the user terminal;
receiving, from the user terminal, a transition command to a project-type chat window and information regarding a project execution period;
in response to receipt of the transition command, determining a context retention period for the project-type chat window using the information regarding the project execution period;
automatically generating a prompt for generating, using the first LLM, a second response to a second query input from the user terminal, wherein the prompt is automatically generated to include the second query and information on one of a plurality of topics corresponding to the project-type chat window designated in the second query, and the second response is generated in consideration of contexts of a plurality of conversations during the context retention period of the project-type chat window; and
transmitting the second response received from the first LLM using the prompt, as a response to the second query, to the user terminal.
